(19) United States
(12) Patent Application Publication
(10) Pub. No.: US 2012/0109500 A1
(43) Pub. Date: May 3, 2012

(54) METHOD AND DEVICE FOR OPERATING AN INTERNAL COMBUSTION ENGINE

(76) Inventors: Johannes Beer, Regensburg (DE); Josef Kainz, Salching (DE)

(21) Appl. No.: 13/383,123

(22) PCT Filed: Jun. 16, 2010
(86) PCT No.: PCT/EP2010/058459

§ 371 Date: Jan. 9, 2012

(30) Foreign Application Priority Data
Jul. 7, 2009 (DE) 10 2009 032 064.4

(51) Int. Cl. F02D 28/00

(52) U.S. Cl. 701/103

(57) ABSTRACT

In a method for operating an internal combustion engine having an intake tract and one injection valve per cylinder, a lambda controller having an associated lambda sensor for correcting an air-fuel ratio in the combustion chamber, an engine operating temperature is detected and a air mass target value in the combustion chamber is determined as a function of an engine operating state. When the lambda controller is deactivated, a first adaptation value is determined as a function of the captured operating temperature, of the determined air mass target value, and a prescribed first weighting value. A second adaptation value is further determined as a function of the determined air mass target value and a prescribed second weighting value. The metering of the fuel mass and/or a model of the air mass fed into the combustion chamber is corrected as a function of the first and second adaptation value.

### CROSS-REFERENCE TO RELATED APPLICATIONS

This application is a U.S. National Stage Application of International Application No. PCT/EP2010/058459 filed Jun. 16, 2010, which designates the United States of America, and claims priority to German Application No. 10 2009 032 064.4 filed Jul. 7, 2009, the contents of which are hereby incorporated by reference in their entirety.

### TECHNICAL FIELD

The invention relates to a method and to a device for operating an internal combustion engine. The internal combustion engine comprises an intake section in which an air mass flow can be fed to a combustion space of a cylinder. In addition, the internal combustion engine comprises one injection valve per cylinder for metering a fuel mass into the combustion space of the corresponding cylinder. The internal combustion engine also has a lambda controller with an assigned lambda probe for correcting an air/fuel ratio in the combustion space of the corresponding cylinder.

### SUMMARY

According to various embodiments, a method and a device which permit reliable and efficient operation of an internal combustion engine can be provided.

According to various embodiments, a method for operating an internal combustion engine which comprises an intake section in which an air mass flow can be fed to a combustion space of a cylinder and which comprises one injection valve per cylinder for metering a fuel mass into the combustion space of the corresponding cylinder and which comprises a lambda controller with an assigned lambda probe for correcting an air/fuel ratio in the combustion space of the corresponding cylinder, may comprise:—an operating temperature of the internal combustion engine is sensed,—a setpoint value of the air mass in the combustion space is determined as a function of an operating state of the internal combustion engine, when the lambda controller is not active,—a first adaptation value is determined as a function of the sensed operating temperature, of the determined setpoint value of the air mass and a predefined first weighting value,—a second adaptation value is determined as a function of the determined setpoint value of the air mass and a predefined second weighting value, and—the metering of the fuel mass and/or modeling of the air mass fed to the combustion space are corrected as a function of the first and second adaptation values.

According to a further embodiment, when the lambda controller is active,—a setpoint value of the air/fuel ratio can be determined as a function of the predefined operating state of the internal combustion engine,—a current air/fuel ratio can be sensed by means of the lambda probe,—the first and second weighting values can be adapted as a function of the setpoint value of the air/fuel ratio and the sensed current air/fuel ratio,—the first adaptation value can be determined as a function of the sensed operating temperature, the determined setpoint value of the air mass and the adapted first weighting value,—the second adaptation value can be determined as a function of the determined setpoint value of the air mass and the adapted second weighting value,—the metering of the fuel mass and/or the modeling of the air mass fed to the combustion space can be corrected as a function of the first and second adaptation values,—the first and second weighting values can be predefined as a function of the adapted first and second weighting values when the lambda controller is not active. According to a further embodiment, the metering of the fuel mass and/or the modeling of the air mass fed to the combustion space can be corrected independently of the first adaptation value if the operating temperature is higher than a predefined first temperature threshold. According to a further embodiment, the first adaptation value can be determined independently of the sensed operating temperature if the sensed operating temperature is lower than a predefined second temperature threshold, wherein the second temperature threshold is lower than the first temperature threshold.

According to a further embodiment, the first adaptation value can be determined as a function of the sensed operating temperature and the first and second temperature threshold if the sensed operating temperature is lower than or equal to the first temperature threshold and higher than or equal to the second temperature threshold. According to a further embodiment,—a value of the first weighting value can be stored if the operating temperature of the internal combustion engine is equal to the first temperature threshold,—a first value of the second weighting value can be stored if the operating temperature of the internal combustion engine is equal to the first temperature threshold,—a second value of the second weighting value can be stored at an end of the respective operating cycle of the internal combustion engine,—at the start of a subsequent operating cycle of the internal combustion engine, the first weighting value can be predefined as a function of the stored value of the first weighting value and the stored first and second values of the second weighting value.

According to another embodiment, in a device for operating an internal combustion engine which comprises an intake section in which an air mass flow can be fed to a combustion space of a cylinder and which comprises one injection valve per cylinder for metering a fuel mass into the combustion space of the corresponding cylinder and which comprises a lambda controller with an assigned lambda probe for correcting an air/fuel ratio in the combustion space of the corresponding cylinder, the device may be designed—to sense an operating temperature of the internal combustion engine,—to determine a setpoint value of the air mass in the combustion space as a function of an operating state of the internal combustion engine, when the lambda controller is not active,—to determine a first adaptation value as a function of the sensed operating temperature, of the determined setpoint value of the air mass and a predefined first weighting value,—to determine a second adaptation value as a function of the determined setpoint value of the air mass and a predefined second weighting value, and—to correct the metering of the fuel mass and/or modeling of the air mass fed to the combustion space as a function of the first and second adaptation values.

According to yet another embodiment, a method for operating an internal combustion engine which comprises an intake section in which an air mass flow can be fed to a combustion space of a cylinder and which comprises one injection valve per cylinder for metering a fuel mass into the combustion space of the corresponding cylinder and which comprises a load sensor for determining the air mass in the intake section, may comprise:—an operating temperature of the internal combustion engine is sensed,—a setpoint value of the air mass in the combustion space is determined as a function of an operating state of the internal combustion engine,—a current air mass is determined by means of the load sensor,—a predefined third and fourth weighting value are predefined as a function of the setpoint value of the air mass and the determined current air mass,—a third adaptation value is determined as a function of the sensed operating temperature, of the determined setpoint value of the air mass and the third weighting value,—a fourth adaptation value is determined as a function of the determined setpoint value of the air mass and the fourth weighting value, and—modeling of the air mass fed to the combustion space is corrected as a function of the third and fourth adaptation values.

According to a further embodiment of the above method,—a value of the third weighting value can be stored if the operating temperature of the internal combustion engine is equal to the third temperature threshold,—a first value of the fourth weighting' value can be stored if the operating temperature of the internal combustion engine is equal to the first temperature threshold,—a second value of the fourth weighting value can be stored at an end of the respective operating cycle of the internal combustion engine, and—at the start of a subsequent operating cycle of the internal combustion engine, the third weighting value can be predefined as a function of the stored value of the third weighting value and the stored first and second values of the fourth weighting value. According to a further embodiment of the above method, the modeling of the air mass fed to the combustion space can be corrected independently of the third adaptation value if the operating temperature is higher than a predefined third temperature threshold. According to a further embodiment of the above method, the third adaptation value can be determined independently of the sensed operating temperature if the sensed operating temperature is lower than a predefined fourth temperature threshold, wherein the fourth temperature threshold is lower than the third temperature threshold. According to a further embodiment of the above method, the third adaptation value can be determined as a function of the sensed operating temperature and the third and fourth temperature threshold if the sensed operating temperature is lower than or equal to the third temperature threshold and higher than or equal to the fourth temperature threshold.

According to yet another embodiment, a device for operating an internal combustion engine which comprises an intake section in which an air mass flow can be fed to a combustion space of a cylinder and which comprises one injection valve per cylinder for metering a fuel mass into the combustion space of the corresponding cylinder and which comprises a load sensor for determining the air mass in the intake section, may be designed—to sense an operating temperature of the internal combustion engine,—to determine a setpoint value of the air mass in the combustion space as a function of an operating state of the internal combustion engine,—to determine a current air mass by means of the load sensor,—to predefine a predefined third and fourth weighting value as a function of the setpoint value of the air mass and the determined current air mass,—to determine a third adaptation value as a function of the sensed operating temperature, of the determined setpoint value of the air mass, and as a function of the third weighting value,—to determine a fourth adaptation value as a function of the determined setpoint value of the air mass and the fourth weighting value, and—to correct modeling of the air mass fed to the combustion space as a function of the third and fourth adaptation values.

### BRIEF DESCRIPTION OF THE DRAWINGS

Exemplary embodiments are explained in more detail below with reference to the schematic drawings, in which:

FIG. 1 shows an internal combustion engine,

FIG. 2 is a schematic illustration of an adaptation,

FIG. 3 shows temperature-dependent correction, and

FIG. 4 shows a plurality of timing diagrams.

Elements with the same design or function are characterized by the same reference symbols in all the figures.

### DETAILED DESCRIPTION

According to various embodiments and a first and a second aspect, in a method and a corresponding device for operating an internal combustion engine which comprises an intake section in which an air mass flow can be fed to a combustion space of a cylinder, the internal combustion engine comprises one injection valve per cylinder for metering a fuel mass into the combustion space of the corresponding cylinder. Furthermore, the internal combustion engine comprises a lambda controller with an assigned lambda probe for correcting an air/fuel ratio in the combustion space of the corresponding cylinder. In this context, an operating temperature of the internal combustion engine is sensed and a setpoint value of the air mass in the combustion space is determined as a function of an operating state of the internal combustion engine. When the lambda controller is not active, a first adaptation value is determined as a function of the sensed operating temperature, of the determined setpoint value of the air mass and a predefined first weighting value. In addition, a second adaptation value is determined as a function of the determined setpoint value of the air mass and a predefined second weighting value. Furthermore, the metering of the fuel mass and/or modeling of the air mass fed to the combustion space are corrected as a function of the first and second adaptation values.

This has the advantage that a load sensor is not necessary for operating the internal combustion engine,' and the internal combustion engine can therefore be manufactured particularly cost-effectively. In addition, reliable and low-emission operation of the internal combustion engine is made possible. The operating temperature is preferably sensed as a temperature of a cooling medium of the internal combustion engine, for example of the cooling water. The setpoint value of the air mass is preferably determined on the basis of a predefined model, wherein the operating state of the internal combustion engine is represented, for example, by a rotational speed and a load of the internal combustion engine. The first adaptation value represents, in particular, a first air mass error during cold operation of the internal combustion engine. The cold operation is characterized in that the sensed operating temperature is lower than a predefined first temperature threshold. The cold operation can typically be assigned a first time period within which the lambda controller is not active owing to the lambda probe which is not operationally warm. In addition, the cold operation can be assigned a second time period within which the lambda controller is active, but the operating temperature is still lower than the predefined first temperature threshold. As a result, the second adaptation value preferably represents a second air mass error when the lambda controller is active in the cold operating mode and/or warm operating mode.

In particular, the metering of the fuel mass and the modeling of the air mass fed to the combustion space can be corrected as a function and, respectively, independently of the first and second weighting value and the operating temperature. However, in addition the modeling of the air mass fed to the combustion space and the metering of the fuel mass can be corrected as a function and, respectively, independently of the first and second weighting value and the operating temperature. The weighting values are embodied, for example, as weighting factors. The air mass fed to the combustion space is preferably modeled on the basis of one or more predefined air mass models, for example on the basis of predefined characteristic diagrams.

The metering of the fuel mass into the combustion space of the internal combustion engine comprises direct metering of the fuel mass into the combustion space and metering of the fuel mass into an intake section of the internal combustion engine.

The correction of the metering of the fuel mass and/or the modeling of the air mass fed to the combustion space preferably take place within the scope of pilot control of the fuel mass and/or of the air mass.

The first and second weighting values are preferably stored values which were determined within the scope of a previous operating cycle of the internal combustion engine. An operating cycle correlates to a time period from starting of the internal combustion engine up to subsequent switching off of the internal combustion engine.

According to one embodiment of the first and second aspects, when the lambda controller is active, a setpoint value of the air/fuel ratio is determined as a function of the predefined operating state of the internal combustion engine, and a current air/fuel ratio is sensed by means of the lambda probe. In addition, when the lambda controller is active, the first and second weighting values are adapted as a function of the setpoint value of the air/fuel ratio and the sensed current air/fuel ratio. Furthermore, the first adaptation value is determined as a function of the sensed operating temperature, the determined setpoint value of the air mass and the adapted first weighting value. The second adaptation value is determined as a function of the determined setpoint value of the air mass and the adapted second weighting value. The metering of the fuel mass and/or the modeling of the air mass fed to the combustion space are corrected as a function of the first and second adaptation values. The first and second weighting values are predefined as a function of the adapted first and second weighting values when the lambda controller is not active. This has the advantage that within the second time period of the cold operating mode, in addition to taking into account the operating temperature it is possible to adapt the weighting values and therefore particularly low-emission operation of the internal combustion engine is made possible. The setpoint value of the air/fuel ratio is preferably determined on the basis of a predefined model. The predefinition of the first and second weighting value as a function of the adapted first and second weighting values is, for example, also carried out when the internal combustion engine starts. In this context, it is possible, for example, to assign the adapted first and second weighting values respectively to the first and second weighting values when the lambda controller is not active.

According to a further embodiment of the first and second aspects, the first weighting value is adapted more quickly than the second weighting value. The adaptation is preferably faster by a factor of two, and therefore permits particularly fast adaptation in the cold operating mode and therefore particularly low-emission operation of the internal combustion engine.

According to a further embodiment of the first and second aspects, the metering of the fuel mass and/or the modeling of the air mass fed to the combustion space are corrected independently of the first adaptation value if the operating temperature is higher than a predefined first temperature threshold. As a result, the first adaptation value is taken into account only within a predefined temperature range of the internal combustion engine, and outside the temperature range only the second adaptation value is taken into account and the second weighting value adapted. This permits low-emission operation of the internal combustion engine without a load sensor, that is to say for example without an intake manifold pressure sensor or air mass sensor. A state in which the operating temperature is higher than the predefined first temperature threshold represents a warm operating mode of the internal combustion engine.

According to a further embodiment of the first and second aspects, the first adaptation value is determined independently of the sensed operating temperature if the sensed operating temperature is lower than a predefined second temperature threshold. The second temperature threshold is lower than the first temperature threshold. If the operating temperature of the internal combustion engine in the cold operating mode is below the predefined second temperature threshold, for example when the internal combustion engine starts, the first adaptation value is only determined as a function of the predefined first weighting value and independently of the sensed operating temperature. This permits reliable operation of the internal combustion engine, in particular reliable starting of the internal combustion engine.

According to a further embodiment of the first and second aspects, the first adaptation value is determined as a function of the sensed operating temperature and the first and second temperature threshold if the sensed operating temperature is lower than or equal to the first temperature threshold and higher than or equal to the second temperature threshold. The first adaptation value is determined as a function of the value of the sensed operating temperature and the values of the predefined first and second temperature thresholds. This permits reliable and low-emission operation of the internal combustion engine.

According to a further embodiment of the first and second aspects, a value of the first weighting value and a first value of the second weighting value are stored if the operating temperature of the internal combustion engine is equal to the first temperature threshold. In addition, a second value of the second weighting value is stored at an end of the respective operating cycle of the internal combustion engine. At the start of a subsequent operating cycle of the internal combustion engine, the first weighting value is predefined as a function of the stored value of the first weighting value and the stored first and second values of the second weighting value. As a result, the values of the first and second weighting values which are adapted in a preceding operating cycle are available at the start of a new operating cycle and therefore permit reliable starting of the internal combustion engine, in particular at very cold operating temperatures, and efficient and low-emission operation of the internal combustion engine. The end of the respective operating cycle correlates to a switch-off time of the internal combustion engine, and the start of the respective operating cycle correlates to a starting time of the internal combustion engine.

According to various embodiments and to a third and fourth aspect, in a method and a corresponding device for operating an internal combustion engine which comprises an intake section in which an air mass flow can be fed to a combustion space of a cylinder, the internal combustion engine also comprises one injection valve per cylinder for metering a fuel mass into the combustion space of the corresponding cylinder. The internal combustion engine also comprises a load sensor for determining the air mass in the intake section. In this context, an operating temperature of the internal combustion engine is sensed, and a setpoint value of the air mass in the combustion space is determined as a function of an operating state of the internal combustion engine. A current air mass is determined by means of the load sensor. A predefined third and fourth weighting value are predefined as a function of the setpoint value of the air mass and the determined current air mass. A third adaptation value is determined as a function of the sensed operating temperature, of the determined setpoint value of the air mass and the third weighting value. A fourth adaptation value is determined as a function of the determined setpoint value of the air mass and the fourth weighting value. The modeling of the air mass fed to the combustion space is corrected as a function of the third and fourth adaptation values. As a result, reliable and low-emission operation of the internal combustion engine is made possible. In particular, when a load sensor is present, an active or inactive lambda controller which is present is not taken into account in the correction of the modeling of the air mass fed to the combustion space. That is to say the third and fourth weighting values are preferably adapted directly after the starting of the internal combustion engine. As a result, the third adaptation value takes into account not only the sensed operating temperature but also the adapted third weighting values and represents, in particular, an air mass error during a cold operating mode of the internal combustion engine. The cold operating mode is characterized by the fact that the sensed operating temperature is lower than a predefined third temperature threshold.

The modeling of the air mass fed to the combustion space is preferably corrected within the scope of pilot control of the air mass.

The third and fourth weighting values are preferably stored values which are determined in a previous operating cycle of the internal combustion engine and stored. The load sensor is preferably embodied as an air mass sensor or intake manifold pressure sensor.

According to one embodiment of the third and fourth aspects, a value of the third weighting value and a first value of the fourth weighting value are stored if the operating temperature of the internal combustion engine is equal to the third temperature threshold. A second value of the fourth weighting value is stored at an end of the respective operating cycle of the internal combustion engine. At the start of a subsequent operating cycle of the internal combustion engine, the third weighting value is predefined as a function of the stored value of the third weighting value and the stored first and second values of the fourth weighting value. As a result, the values of the third and fourth weighting values which are adapted in a preceding operating cycle are available at the start of a new operating cycle and therefore permit reliable starting of the internal combustion engine, in particular at very cold operating temperatures, and efficient and low-emission operation of the internal combustion engine.

According to a further embodiment of the third and fourth aspects, the modeling of the air mass fed to the combustion space is corrected independently of the third adaptation value if the operating temperature is higher than a predefined third temperature threshold. As a result, the third adaptation value is taken into account only within a predefined temperature range of the internal combustion engine, and outside the temperature range only the fourth adaptation value is taken into account and the fourth weighting value adapted. This permits low-emission operation of the internal combustion engine with a load sensor. A state in which the operating temperature is higher than the predefined third temperature threshold represents a warm operating mode of the internal combustion engine.

According to a further embodiment of the third and fourth aspects, the third adaptation value is determined independently of the sensed operating temperature if the sensed operating temperature is lower than a predefined fourth temperature threshold. The fourth temperature threshold is lower than the third temperature threshold. If the operating temperature of the internal combustion engine is below the predefined fourth temperature threshold in the cold operating mode, for example when the internal combustion engine starts, the third adaptation value is determined only as a function of the predefined third weighting value and independently of the sensed operating temperature. This permits reliable operation of the internal combustion engine, in particular reliable starting of the internal combustion engine.

According to a further embodiment of the third and fourth aspects, the third adaptation value is determined as a function of the sensed operating temperature and the third and fourth temperature threshold if the sensed operating temperature is lower than or equal to the third temperature threshold and higher than or equal to the fourth temperature threshold. The third adaptation value is determined as a function of the value of the sensed operating temperature and the values of the predefined third and fourth temperature threshold. This permits reliable and low-emission operation of the internal combustion engine.

According to various embodiments a method or a device for an injection system of a motor vehicle can be formed in which it is possible to dispense with the use of, in particular, a load sensor for measuring the air mass flow or the intake manifold pressure. As a result, the overall system can be manufactured very much more cost-effectively without relevant emission regulations being infringed. Here, a cold adaptation means is provided for a cold internal combustion engine.

In a warm adaptation means, essentially an air/fuel ratio is observed by means of a lambda probe, the measured values of which are evaluated by comparison with predefined model values as a function of operating parameters of the internal combustion engine. A current rotational speed N and a current load MAF are used as operating parameters, wherein the load MAF is obtained from an adaptable model. The observed deviations are learnt by means of an adaptation during the ongoing operation of the internal combustion engine. On the basis of the structure of the deviations, an attempt is made to analyze whether the cause of the deviation has occurred in the air path and/or in the fuel path. On the basis of this assignment, adaptation values are determined iteratively and are then used to correct the pilot control of the injection system. In this way it is possible to set very precisely a stoichiometric air/fuel ratio in every operating state of the internal combustion engine. This ensures compliance with relevant exhaust gas regulations even without use of a load sensor.

In the cold adaptation means, an additional adaptation correction with respect to the warm adaptation as a function of an operating temperature, in particular a cooling water temperature, is learnt on the basis of observation of an enlarged air mass flow through a throttle valve (with the same valve position) during the first minutes after the cold start of the internal combustion engine, and is used essentially for corresponding pilot control correction of the air mass. As a result, in the case of a cold start of the internal combustion engine a precise pilot control of an injection of fuel is also possible in order to comply with predefined emission requirements without a load sensor.

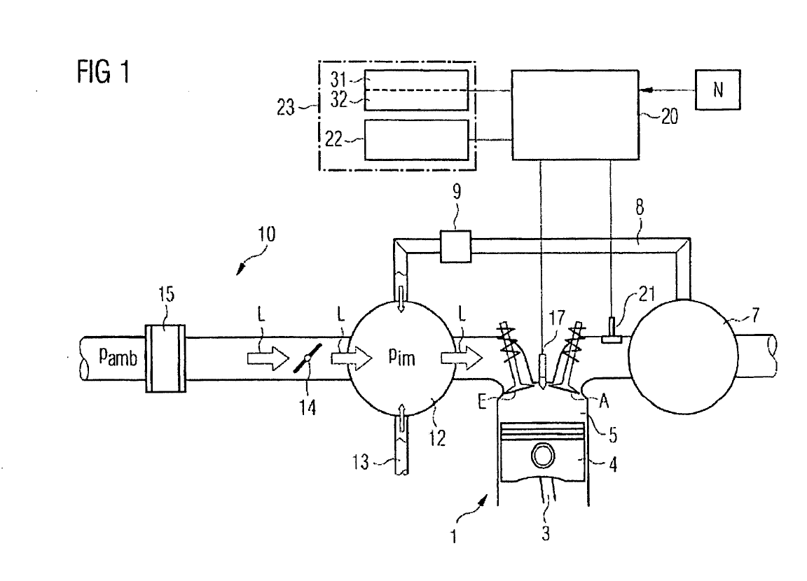

FIG. 1 is a schematic illustration of an internal combustion engine 1, for example a petrol engine, with a cylinder 5 in which a piston 4 is arranged, said piston 4 being alternately driven by a connecting rod 3 and in the process moving the piston 4 upward or downward. The combustion space of the cylinder 5 is coupled to an intake section 10 or to an exhaust gas system 7 via an intake manifold 12. An air filter 15 is arranged in the intake section 10, and a throttle valve 14, with which an airstream L can be controlled with a corresponding air mass within the intake section 10, for example directly or indirectly by means of an accelerator pedal, is arranged downstream of said air filter 15.

Furthermore the exhaust gas system 7 is coupled to the intake manifold 12 via an exhaust gas recirculation system 8 and an EGR valve 9. The operating-point-dependent intake manifold pressure Pim is present within the intake manifold 12. Furthermore, a surrounding pressure sensor (AMP sensor) is provided and can be used to measure an ambient air pressure Pamb. Furthermore, an inlet 13 for venting the crank housing is provided on the intake manifold 12. The combustion space of the cylinder 5 is opened or closed by means of an inlet valve E, with the result that the fresh air which is fed to the cylinder 5 can be controlled by means of the inlet valve E. Furthermore, an outlet valve A, with which the exhaust stream downstream in the direction of the exhaust gas system 7 can be controlled, is provided on the combustion space. Furthermore, a fuel injector 17 is arranged on the cylinder 5 (cylinder head) and can be used to inject the corresponding quantity of fuel.

A lambda probe 21, with which a residual oxygen content can be sensed in the exhaust stream, is arranged at the outlet of the cylinder 5, in the region of the exhaust gas system 7. The measured values of the lambda probe 21 are an indicator of the lambda value of the air/fuel mixture.

The lambda probe 21 is electrically coupled to an engine control unit (programmable control unit) 20 which processes the measured values of the lambda probe 21 in conjunction with a lambda controller 22. A program with an algorithm with which a necessary fuel mass is calculated in accordance with the current load from model values of the air path at the intake section 10 is stored in the engine control unit 20. For this purpose, the engine control unit 20 is connected to the fuel injector 17 which can be correspondingly actuated. Furthermore, a memory 23 is provided in which measurement data, models and programs with the algorithm (for example block 31, 32) are stored. In addition, an inlet for a rotational speed N is provided for the engine control unit 20. The engine control unit 20 is preferably designed to carry out a method for operating the internal combustion engine.

By considering how various tolerances in the air path and fuel path act on a lambda controller output FAC_LAM_COR it is possible to define the following structure of the adaptation function:

$$FAC\_LAM \_AD ( N , MAF ) = {f}_{\{ {w}_{i} \}} ( N , M A F ) + \frac{100 \% \cdot {w}_{OFS}^{MFF}}{MAF\_STK} + \frac{100 \% \cdot {w}_{OFS}^{MAF}}{MAF\_SP} \qquad ( 1 )$$

In this context, the first term represents a factor error in the air/fuel path. It has become apparent that the factor corrections which are to be carried out in the air path and fuel path depend on the operating state of the internal combustion engine 1, in particular by means of the rotational speed N and a load which is represented by the air mass flow per working cycle MAF_STK. Therefore, the function ƒ(N,MAF) is stipulated as a function of the rotational speed N and the load MAF=MAF_STK, for the two factor corrections which without a load sensor can then only be observed as a sum. This function can be implemented, for example, by a neural network of the type LMN (local model network) which is parameterized by weighting values

The second term represents an offset error in the fuel path. The resulting factor correction is indirectly proportional to the load MAF=MAF_STK. The fuel weighting factor w_{OFS}^{MFF} is the ors associated proportionality constant. It is proportional to the offset error in the fuel path.

In addition, the third term represents an offset error in the air path. It can also be referred to as a second adaptation value which comprises a second weighting value w_{OFS}^{MAF}. Here, the mixture error is specified indirectly proportionally to a setpoint value MAF_SP of the air mass flow (in kg/h). The second weighting value w_{OFS}^{MAF} is the associated proportionality constant. It corresponds to the offset MAF_OFS of the air mass flow.

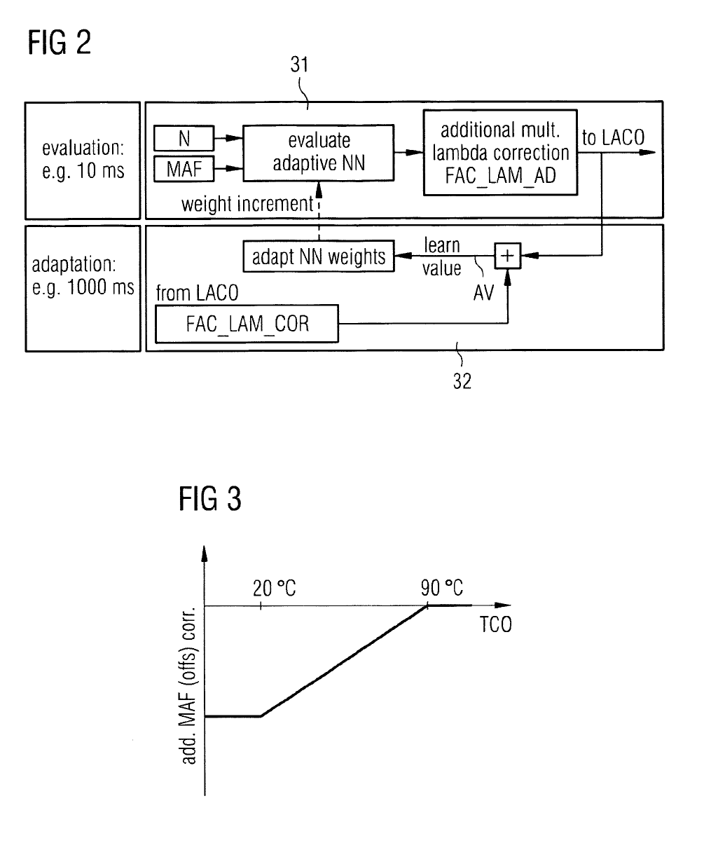

FIG. 2 represents the structure of an adaptation function FAC_LAM_AD which is conducted through the lambda controller output FAC_LAM_COR. The adaptation function FAC_LAM_AD is determined by means of the adaptive neural network NN (see equation 1).

The adaptation function FAC_LAM_AD is evaluated as a function of the operating state, represented by the rotational speed N and the load MAF, in a high-speed timing pattern, for example ms. The value which is determined for the adaptation function FAC_LAM_AD is transferred to the mixture control function LACO as an additional multiplicative correction (pilot control) of the injection quantity. In the adaptation part, which can be carried out in a relatively slow timing pattern, that is to say for example 1000 ms, the weightings, which are also referred to as weighting values, of the adaptive neural network NN are always adapted to the effect that in the steady state no lambda control intervention is necessary anymore and therefore the lambda controller output FAC_LAM_COR is zero. Adaptation values AD represent the sum of the respective current value of the adaptation function FAC_LAM_AD and the respective current value of the lambda controller output FAC_LAM_COR. In an ideal case, the entire injection quantity correction is preferably performed by the adaptive neural network NN, and therefore the lambda controller 22 which is based on the lambda signal is completely relieved. This permits considerable improvement of the emission behavior, since emission-impairing deviations from the desired stoichiometric composition of the fuel/air mixture are also prevented or at least considerably reduced in the dynamic operating mode.

The adaptation of the weighting values wᵢ, w_{OFS}^{MFF}, w_{OFS}^{MAF} is carried out in the engine controller 20. Because of its small resource requirements and stability, the LMS algorithm (least mean squares) is suitable for this, for example. This algorithm is a real-time-capable, iterative algorithm for solving a least squares regression problem. It can be described as follows: at each adaptation step k−1->k an updated value is calculated for one or more weighting values according to the rule:

wᵢ^{(k)}=wᵢ^{(k-1)}+ηᵢ·xᵢ^{(k)}·e^{(k)}

e^{(k)}=FAC_{—}LAM_COR^{(k)′} likewise for w_{OFS}^{MAF} and w_{OFS}^{MFF} (2)

Here, xᵢ^{(k)} is the ith regressor at the time k which is calculated according to rules which are to be suitably selected. The increments ηᵢ determine the adaptation speed and are implemented by suitably selected calibration variables. In addition, reference is made here to O. Nelles, loc. cit., page 62, and to B. Widrow & S. Stearns, Adaptive Signal Processing, Prentice-Hall, London, 1985.

It has become apparent that after replacement of the load sensor by the illustrated warm adaptation means, an uncritical emission behavior is possible for an operationally warm internal combustion engine 1. However, in the case of a cold start and warm running considerably increased emissions (above all hydrocarbons HC and carbon monoxide CO) occur which place in question the possibility of achieving the emission objective. The warm running represents here a cold operating mode of the internal combustion engine.

The cause of this behavior is that to a considerable degree different air path tolerances occur in a cold internal combustion engine than for a warm internal combustion engine. However, with the method illustrated hitherto in the case of a cold start the weighting values which are previously adapted for the operationally warm internal combustion engine are used, said values being, however, not correct because of the temperature dependence of the tolerances. In addition, soon after the cold start the internal combustion engine (air path and fuel path) is operated completely with pilot control since the lambda probe 21 is still not active and there is no load sensor present. Cold adaptation for the warm running contributes in a suitable way to limiting the HC emissions.

After starting, the internal combustion engine 1 is operated with the objective of a stoichiometric mixture (lambda=1).

The lambda controller 22 is typically only activated after a delay after the start of the internal combustion engine 1, for example 15 seconds after the start, owing to the not yet operationally warm lambda probe 21.

Approximately 90% of the hydrocarbons which are emitted during the test cycle are produced in the first 30 seconds after the start.

In this time the catalytic converter is brought to the operating temperature and has not yet reached its full conversion capability.

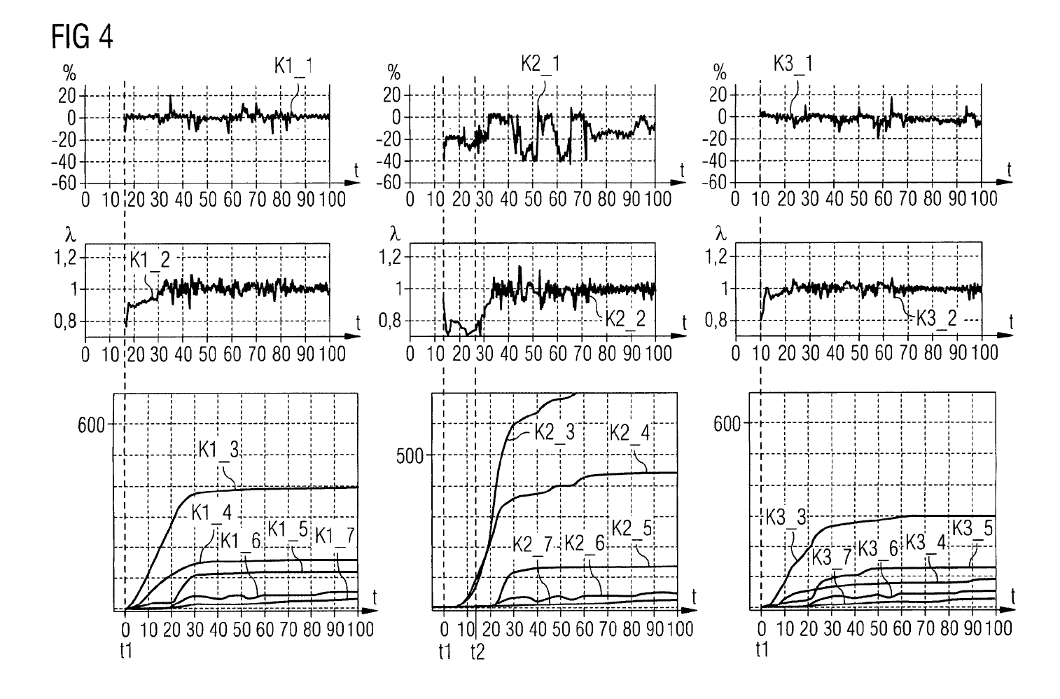

FIG. 4 illustrates air mass deviations (upper line), lambda values upstream of the catalytic converter (middle line) and cumulated HC values (lower line) for the series system with the load sensor (left-hand column), the system without a load sensor only with warm adaptation (middle column) and with additional cold adaptation (right-hand column). The measured values are respectively shown for the first 100 seconds of an FTP test.

As is shown in FIG. 4, after the cold start large air mass deviations (model value in comparison with the measured value of the HFM) occur if there is no load sensor present and only a warm internal combustion engine is adapted. This leads to corresponding rich deviations of the mixture, which can be compensated at a time t2, for example 15 seconds after a starting time t1, and also not yet by the lambda controller 22. As a consequence, very high hydrocarbon emissions HC occur. The positive effect of an additional cold adaptation, both on the air mass model accuracy as well as the emissions, are clear in the right-hand column in FIG. 4. The cold adaptation function which is used here is illustrated more precisely below.

It has the following features here:
can be integrated into an existing (warm) adaptation means,
temperature-dependent correction, a maximum for a cold internal combustion engine,
no correction and no learning for a warm internal combustion engine (cooling water temperature TCO above the threshold value),
air mass correction of the offset type, i.e. an additional, temperature-dependent offset MAF_OFS of the air mass flow is to be adapted, and
coordination with the already present adaptation means of the offset MAF_OFS of the air mass flow is possible.

The following expansion of equation (3) satisfies these requirements:

$$FAC\_LAM \_AD ( N , MAF , TCO ) == {f}_{\{ {w}_{i} \}} ( N , MAF ) + \frac{100 \% \cdot {w}_{OFS}^{MFF}}{MAF\_STK} + \frac{100 \% \cdot {w}_{OFS}^{MAF}}{MAF\_SP} + \frac{100 \% \cdot {w}_{OFS\_TCO}^{MAF}}{MAF\_SP} \cdot g ( TCO ) \\ g ( TCO ) = \{ \begin{matrix}1 & for TCO < C\_TCO \_BOL \\ 0 & for TCO > C\_TCO \_TOL \\ \frac{TCO - C\_TCO \_TOL}{C\_TCO \_BOL - C\_TCO \_TOL} & else\end{matrix} \qquad ( 3 )$$

The fourth term can be referred to as a first adaptation value whose first weighting value w_{OFS}_{_{—}}_{TCO}^{MAF} can be interpreted as an additional offset MAF_OFS of the air mass flow for low temperatures. The first weighting value w_{OFS}_{_{—}}_{TCO}^{MAF} is adapted according to equation (2) like the other weighting values, wherein a regressor x_{OFS}_{_{—}}_{TCO}^{MAF,(k)} is used for the first weighting value as

$${x}_{OFS\_TCO}^{MAK , ( k )} = \frac{100 \%}{MAF\_SP} \cdot g ( TCO ) \qquad ( 4 )$$

The temperature value g(TCO) is predefined as a constant value at an operating temperature TCO which is lower than a second predefined threshold value C_TCO_BOL, and is predefined as zero at an operating temperature TCO which is higher than a first predefined threshold value C_TCO_TOL, i.e. the first adaptation value is not taken into account at this operating temperature.

At an operating temperature TCO which is lower than or equal to the first threshold value C_TCO_TOL and higher than or equal to the second threshold value C_TCO_BOL, the temperature value g(TCO) is obtained as a function of the two threshold values and the current operating temperature TCO, which preferably represents a temperature of a cooling medium, for example cooling water, of the internal combustion engine.

The additional, temperature-dependent correction which is obtained here is illustrated in FIG. 3. In this context, the first and second threshold values C_TCO_TOL, C_TCO_BOL are predefined, wherein the first threshold value C_TCO_TOL has, for example, a value of 90° C., and the second threshold value C_TCO_BOL has, for example, a value of 20° C.

It is apparent that the first adaptation value for a warm internal combustion engine 1 (TCO>C_TCO_TOL) does not have any influence on the adaptation function FAC_LAM_AD, which also ends the adaptation after the warming process. During the warming up, i.e. when the lambda controller is activated and the cold operating mode, the first and second weighting values w_{OFS}_{_{—}}_{TCO}^{MAF}, w_{OFS}^{MAF} are adapted simultaneously. Furthermore it is advantageous to learn the first weighting value w_{OFS}_{_{—}}_{TCO}^{MAF} more quickly (for example by a factor of 2) than the second weighting value w_{OFS}^{MAF}. Furthermore, the learning of the first weighting value w_{OFS}_{_{—}}_{TCO}^{MAF} should be permitted only within predefinable temperature limits, for example TCO>10° C. and TCO<80° C.

It is necessary to ensure that the entire offset correction, represented by a value w_{OFS}^{MAF,after WUP} of the first weighting value w_{OFS}_{_{—}}_{TCO}^{MAF} and a first value w_{OFS}^{MAF,after WUP} of the second weighting value w_{OFS}^{MAF}, which is learnt after the warming up, is used at the next cold start of the internal combustion engine. In order to bring this about, the first value w_{OFS}^{MAF,afterWUP} after the warming up is stored. In the rest of the driving cycle, the value of the second weighting value w_{OFS}^{MAF} can change, with the result that it can assume a second value w_{OFS}^{MAF,end} at the end. The value w_{OFS}^{MAF,end} for the warm offset and w_{OFS}^{MAF,afterVUP}+w_{OFS}^{MAF,afterWUP}−w_{OFS}^{MAF,end} as a further value for the cold offset are stored in the non-volatile memory for use in a subsequent driving cycle. This coordination of the two weighting values is necessary to ensure that a total offset which is adapted during the warming up is used in an unchanged form at the next cold start.

Within the scope of the emission tests which are carried out, it was possible to achieve good results even in the case of cold starts in the region around 0° C. For extreme cold starts, additional changes could be performed, for example a further temperature value g and/or further adaptation values could be taken into account.

In order to ensure the stability of the adaptation, the adaptation steps described above are carried out only under the following conditions:
no input, or only a small input, of fuel by venting the tank,
steady-state operation of the internal combustion engine (limited change in rotational speed/load),
lambda controller active
   =>adaptation only in the stoichiometric operating mode in a system with a lambda jump probe,
no overrun cutoff, and
regressor>threshold value (to be selected suitably for each regressor).

These conditions apply to all adaptations (warm & cold) which basically run in parallel.

The illustrated cold adaptation was used very successfully for reducing the HC emissions in the post-start phase (cf. FIG. 4).

For example, the adapted corrections are used exclusively for correction of the fuel path. By introducing a fuel correction value FAC_LAM_AD_COR for the correction in the fuel path and an air mass correction value MAF_COR for the correction in the air path, the following therefore applies:

FAC_LAM_AD_COR=FAC_LAM_AD(N,MAF)

MAF_COR=0 (5)

Here, the adaptation function FAC_LAM_AD corresponds to the equation (1).

In particular, it is also possible to correct the error at the location where it is caused, that is to say in the air path. In an extension of equation (5), the following regulation is therefore obtained for the calculation of an air path and fuel path correction:

$$FAC\_LAM \_AD ( N , MAF , TCO ) = {f}_{\{ {w}_{i} \}} ( N , MAF ) + \frac{100 \% \cdot {w}_{OFS}^{MFF}}{MAF\_STK} \\ MAF\_COR = {w}_{OFS}^{MAF} + {w}_{OFS\_TCO}^{MAF} \cdot g ( TCO ) \qquad ( 6 )$$

The additive correction in the air path corrects the setpoint value MAF_SP of the air mass flow according to the equation (7), with the result that a corrected value of the air mass flow MAF_KGH is obtained:

MAF_KGH=MAF_SP+MAF_OFS (7)

In particular, by using prior knowledge about typical tolerances of the air path and fuel path, an even more wide-ranging distribution of the learnt correction is advantageous. For example, with a calibration constant C_FAC_DISTR which is to be selected suitably any desired distribution of the factor correction ƒ(N,MAF) between two paths can be achieved:

$$FAC\_LAM \_AD \_COR = C\_FAC \_DIST \cdot {f}_{\{ {w}_{i} \}} ( N , MAF ) + \frac{100 \% \cdot {w}_{OFS}^{MFF}}{MAF\_STK} \\ MAF\_COR = {w}_{OFS}^{MAF} + {w}_{OFS\_TCO}^{MAF} \cdot g ( TCO ) + ( 1 - C\_FAC \_DISTR ) \cdot {f}_{\{ {w}_{i} \}} ( N , MAF ) \cdot \frac{MAF\_SP}{100 \%} \qquad ( 8 )$$

The developed adaptation strategy permits operation for the selected base system without a load sensor while complying with the ULEV/LEV2 emission limit value. Investigations with a reduced exhaust gas purification system showed the robustness.

In systems with a load sensor, a fourth weighting value w_{OFS2}^{MAF} is already typically adapted. However, this fourth weighting value w_{OSF2}^{MAF} is not learnt, as described above, from the lambda controller output FAC_LAM_COR but rather directly from the control error of a predefined intake manifold model AR_RED_DIF_REL, which is obtained in turn from the difference between the measured and modeled air masses. For steady-state operation of the engine, the control error AR_RED_DIF_REL is equal to the percentage deviation of the (uncorrected) modeled air mass from the measured value. The correction of the air path by the adaptation is then calculated in accordance with the following rule:

MAF_OFS=w_{OFS2}^{MAF}. (9)

By analogy with the procedure described above for the case when there is no load sensor, in systems with a load sensor it is possible to learn two corrections separately for the air path and the fuel path. The structure of the adaptation functions is then, for example:

$$FAC\_MAF \_AD ( N , MAF , TCO ) == {f}_{\{ {w}_{i}^{MAF} \}}^{MAF} ( N , MAF ) + \frac{100 \% \cdot {w}_{OFS 2}^{MAF}}{MAF\_SP} + \frac{100 \% \cdot {w}_{OFS\_TCO 2}^{MAF}}{MAF\_SP} \cdot g ( TCO ) \\ FAC\_MFF \_AD ( N , MAF , TCO ) = {f}_{\{ {w}_{i}^{LAM} \}}^{MFF} ( N , MAF ) + \frac{100 \% \cdot {w}_{OFS}^{MFF}}{MAF\_STK} \qquad ( 10 )$$

Here, the temperature value g(TCO) is preferably defined in accordance with the equation (3). The learnt air path correction FAC_MAF_AD and the learnt fuel path correction FAC_MFF_AD can be assigned to the air path or fuel path. Correspondingly, the air mass correction value MAF_COR and the fuel correction value FAC_LAM_AD_COR are calculated for the two paths:

$$MAF\_OFS = FAC\_MAF \_AD \cdot \frac{MAF\_SP}{100 \%} \\ FAC\_LAM \_AD \_COR = FAC\_MFF \_AD \qquad ( 11 )$$

Here, the air path correction MAF_OFS is an absolute correction and the fuel correction value FAC_LAM_AD_COR is a relative correction. The learning rules are obtained in a way analogous to that for equation (2):

wᵢ^{(k),MAF}=wᵢ^{(k-1),MAF}+ηᵢ·xᵢ^{MAF,(k)}·e^{(k),MAF}

e^{(k),MAF}=AR_RED_DIF_REL^{(k)}

wᵢ^{(k),MFF}=wᵢ^{(k-1),MFF}+ηᵢ·xᵢ^{MFF,(k)}·e^{(k),MFF}

e^{(k),MFF}=FAC_LAM_COR^{(k)} (12)

The regressors are defined as follows: xᵢ^{MAF,(k)}=to be selected suitably as a function of the neural network used

$${x}_{OFS}^{MAF , ( k )} = \frac{100 \%}{MAF\_SP} \\ {x}_{OFS\_TCO}^{MAF , ( k )} = \frac{100 \%}{MAF\_SP} \cdot g ( TCO ) \qquad ( 13 )$$

xᵢ^{MIFF,(k)}=to be selected suitably as a function of the neural network used

$${x}_{OFS}^{MFF , ( k )} = \frac{100 \%}{MAF\_SP}$$

A further application of the method which is presented is obtained by changing over from an adaptive correction to a pilot control correction. This approach is appropriate if at least some of the adaptation values are subject to only small fluctuations. Assuming that such effects which are caused, for example, by series variation or aging effects are virtually irrelevant for the temperature-dependent offset mass flow, the changeover from the adaptive system to the pilot-controlled system is shown below for this example.

The first weighting value w_{OFS}_{_{—}}_{TCO}^{MAF} can be determined by measuring the temperature-dependent air mass deviations.

This weighting value w_{OFS} _{_{—}}_{TCO}^{MAF} is subsequently permanently stored in a memory of the engine control unit. No further adaptation is then carried out for this weighting value.

In addition, the dependence of the product of the first weighting value w_{OFS}_{_{—}}_{TCO}^{MAF} can also be measured with the temperature value g(TCO) and stored as a characteristic curve.

The corrections of the air path and fuel path are furthermore calculated for the case without a load sensor as in the equation (8), and with a load sensor present as in the equations (10) and (11).

In this application, merely one additional temperature-dependent pilot-control correction of the air path is therefore performed. The advantages in terms of the improved model accuracy are the same as in the case of the adaptive correction. A disadvantage is in comparison the lack of self-adaptation to possibly present series variation or aging effects. If the assumption of an air mass deviation which is mainly caused by thermal expansion is correct, such effects should be virtually irrelevant.

A large advantage of the illustrated calibrative correction is that it is present at any time and does not have to be firstly learnt. This is significant in particular in the case of an extreme cold start after deletion of the adaptation values. Because of the considerable extent of the necessary correction, for systems without a load sensor starting is no longer possible under such ambient conditions without a correction. Since deletion of the adaptation values can already be triggered by interrupting the voltage supply of the control unit, this problem is completely relevant to practice.

Of course, a combination of adaptive correction and calibrative correction can also be advantageously used.

In summary, the following main features and advantages can be specified:
modeled air mass flow through the throttle valve is corrected as a function of the temperature,
correction occurs through additional, temperature-dependent first adaptation value which disappears for the operationally warm internal combustion engine,
possible interpretation: changed geometry of the air gap in the throttle valve in the case of a warm internal combustion engine because of a different thermal expansion of the plate and housing,
the extent of the correction can be defined by calibration, adaptation or a combination thereof, and
the method can advantageously be combined with the warm adaptation and therefore permits operation of an internal combustion engine without a load sensor accompanied by simultaneous compliance with demanding emission limit values.

FIG. 4 illustrates profiles K1_1, K2_1, K3_1 of an MAF deviation plotted over the time t. The first profile of the MAF deviation K1_1 is related to the series system with a load sensor, the second profile K2_1 is related to the system without a load sensor with only warm adaptation, and the third profile K3_1 is referred to the system without a load sensor with cold adaptation and with warm adaptation.

The time t1 represents a starting time of the internal combustion engine. The time t2 represents a time of approximately 15 s after the starting time of the internal combustion engine.

In the middle line, profiles K1_2, K2_2, K3_2 of lambda values λ upstream of the catalytic converter are represented plotted against the time t. The first profile K2_1 characterizes the lambda values upstream of the catalytic converter in the series system with a load sensor, the second profile K2_2 characterizes the lambda values in the system without a load sensor with only warm adaptation, and the third profile K3_2 characterizes the lambda values in the system without a load sensor and with cold adaptation and warm adaptation.

In the lower line, various profiles of different emissions of pollutants are illustrated, which line was determined within the scope of an emission test. The profiles K1_3-K3_3 therefore represent THC emissions for the respective system. The profiles K1_4-K3_4 represent CO emissions, the profiles K1_5-K3_5 represent NOx emissions, and the profiles K1_7-K3_7 represent CO2 emissions. The profiles K1_6-K3_6 represent the speed of a motor vehicle with a corresponding system.

What is claimed is:

1. A method for operating an internal combustion engine which comprises an intake section in which an air mass flow can be fed to a combustion space of a cylinder and which comprises one injection valve per cylinder for metering a fuel mass into the combustion space of the corresponding cylinder and which comprises a lambda controller with an assigned lambda probe for correcting an air/fuel ratio in the combustion space of the corresponding cylinder, the method comprising the steps of:
sensing an operating temperature of the internal combustion engine,
determining a setpoint value of the air mass in the combustion space as a function of an operating state of the internal combustion engine,
when the lambda controller is not active,
determining a first adaptation value as a function of the sensed operating temperature, of the determined setpoint value of the air mass and a predefined first weighting value,
determining a second adaptation value is as a function of the determined setpoint value of the air mass and a predefined second weighting value (w_{OFS}^{MAF}), and
correcting at least one of the metering of the fuel mass and modeling of the air mass fed to the combustion space as a function of the first and second adaptation values.

2. The method according to claim 1, wherein when the lambda controller is active,
a setpoint value of the air/fuel ratio is determined as a function of the predefined operating state of the internal combustion engine,
a current air/fuel ratio is sensed by means of the lambda probe,
the first and second weighting values are adapted as a function of the setpoint value of the air/fuel ratio and the sensed current air/fuel ratio,
the first adaptation value is determined as a function of the sensed operating temperature, the determined setpoint value of the air mass and the adapted first weighting value,
the second adaptation value is determined as a function of the determined setpoint value of the air mass and the adapted second weighting value,
at least one of the metering of the fuel mass and the modeling of the air mass fed to the combustion space are corrected as a function of the first and second adaptation values,
the first and second weighting values are predefined as a function of the adapted first and second weighting values when the lambda controller is not active.

3. The method according to claim 1, wherein at least one of the metering of the fuel mass and the modeling of the air mass fed to the combustion space are corrected independently of the first adaptation value if the operating temperature is higher than a predefined first temperature threshold.

4. The method according to claim 1, wherein the first adaptation value is determined independently of the sensed operating temperature if the sensed operating temperature is lower than a predefined second temperature threshold, wherein the second temperature threshold is lower than the first temperature threshold.

5. The method according to claim 3, wherein the first adaptation value is determined as a function of the sensed operating temperature and the first and second temperature threshold if the sensed operating temperature is lower than or equal to the first temperature threshold and higher than or equal to the second temperature threshold.

6. The method according to claim 1, wherein
a value
$$( {w}_{OFS\_TCO}^{MAF , afterWUP} )$$
of the first weighting value is stored if the operating temperature of the internal combustion engine is equal to the first temperature threshold,
a first value of the second weighting value is stored if the operating temperature of the internal combustion engine is equal to the first temperature threshold,
a second value of the second weighting value is stored at an end of the respective operating cycle of the internal combustion engine,
at the start of a subsequent operating cycle of the internal combustion engine, the first weighting value is predefined as a function of the stored value
$$( {w}_{OFS\_TCO}^{MAF , afterWUP} )$$
of the first weighting value and the stored first and second values
$$( {w}_{OFS}^{MAF , afterWUP}$$
of the second weighting value.

7. A device for operating an internal combustion engine which comprises an intake section in which an air mass flow can be fed to a combustion space of a cylinder and which comprises one injection valve per cylinder for metering a fuel mass into the combustion space of the corresponding cylinder and which comprises a lambda controller with an assigned lambda probe for correcting an air/fuel ratio in the combustion space of the corresponding cylinder, wherein the device is designed
to sense an operating temperature of the internal combustion engine,
to determine a setpoint value of the air mass in the combustion space as a function of an operating state of the internal combustion engine,
when the lambda controller is not active,
to determine a first adaptation value as a function of the sensed operating temperature, of the determined setpoint value of the air mass and a predefined first weighting value (w_{OFS}_{_{—}}_{TCO}^{MAF}),
to determine a second adaptation value as a function of the determined setpoint value of the air mass and a predefined second weighting value (w_{OFS}^{MAF}), and
to correct at least one of the metering of the fuel mass and modeling of the air mass fed to the combustion space as a function of the first and second adaptation values.

8. A method for operating an internal combustion engine which comprises an intake section in which an air mass flow can be fed to a combustion space of a cylinder and which comprises one injection valve per cylinder for metering a fuel mass into the combustion space of the corresponding cylinder and which comprises a load sensor for determining the air mass in the intake section, the method comprising:
sensing an operating temperature of the internal combustion engine,
determining a setpoint value of the air mass in the combustion space as a function of an operating state of the internal combustion engine,
determining a current air mass by means of the load sensor,
predefining a predefined third and fourth weighting value as a function of the setpoint value of the air mass and the determined current air mass,
determining a third adaptation value as a function of the sensed operating temperature, of the determined setpoint value of the air mass and the third weighting value,
determining a fourth adaptation value as a function of the determined setpoint value of the air mass and the fourth weighting value, and
modeling of the air mass fed to the combustion space is corrected as a function of the third and fourth adaptation values.

9. The method according to claim 8, wherein
a value
$$( {w}_{OFS\_TCO 2}^{MAF , afterWUP} )$$
of the third weighting value is stored if the operating temperature of the internal combustion engine is equal to the third temperature threshold,
a first value
$$( {w}_{OFS 2}^{MAF , afterWUP} )$$
of the fourth weighting value is stored if the operating temperature of the internal combustion engine is equal to the first temperature threshold,
a second value of the fourth weighting value is stored at an end of the respective operating cycle of the internal combustion engine, and
at the start of a subsequent operating cycle of the internal combustion engine, the third weighting value is predefined as a function of the stored value
$$( {w}_{OFS\_TCO 2}^{MAF , afterWUP} )$$
of the third weighting value and the stored first and second values (w_{OFS2}^{MAF,afterWUP}, w_{OFS2}^{MAF,end}) of the fourth weighting value.

10. The method according to claim 8, wherein the modeling of the air mass fed to the combustion space is corrected independently of the third adaptation value if the operating temperature is higher than a predefined third temperature threshold.

11. The method according to claim 8, wherein the third adaptation value is determined independently of the sensed operating temperature if the sensed operating temperature is lower than a predefined fourth temperature threshold, wherein the fourth temperature threshold is lower than the third temperature threshold.

12. The method according to claim 8, wherein the third adaptation value is determined as a function of the sensed operating temperature and the third and fourth temperature threshold if the sensed operating temperature is lower than or equal to the third temperature threshold and higher than or equal to the fourth temperature threshold.

13. A device for operating an internal combustion engine which comprises an intake section in which an air mass flow can be fed to a combustion space of a cylinder and which comprises one injection valve per cylinder for metering a fuel mass into the combustion space of the corresponding cylinder and which comprises a load sensor for determining the air mass in the intake section, wherein the device is designed
to sense an operating temperature of the internal combustion engine,
to determine a setpoint value of the air mass in the combustion space as a function of an operating state of the internal combustion engine,
to determine a current air Mass by means of the load sensor,
to predefine a predefined third and fourth weighting value as a function of the setpoint value of the air mass and the determined current air mass,
to determine a third adaptation value as a function of the sensed operating temperature, of the determined setpoint value of the air mass, and as a function of the third weighting value,
to determine a fourth adaptation value as a function of the determined setpoint value of the air mass and the fourth weighting value, and
to correct modeling of the air mass fed to the combustion space as a function of the third and fourth adaptation values.

14. The device according to claim 7, wherein the device is further configured,
when the lambda controller is active,
to determine a setpoint value of the air/fuel ratio as a function of the predefined operating state of the internal combustion engine,
to sense a current air/fuel ratio by means of the lambda probe,
to adapt the first and second weighting values as a function of the setpoint value of the air/fuel ratio and the sensed current air/fuel ratio,
to determine the first adaptation value as a function of the sensed operating temperature, the determined setpoint value of the air mass and the adapted first weighting value,
to determine the second adaptation value as a function of the determined setpoint value of the air mass and the adapted second weighting value,
to correct at least one of the metering of the fuel mass and the modeling of the air mass fed to the combustion space as a function of the first and second adaptation values,
to predefine the first and second weighting values as a function of the adapted first and second weighting values when the lambda controller is not active.

15. The device according to claim 7, wherein the device is further configured to correct at least one of the metering of the fuel mass and the modeling of the air mass fed to the combustion space independently of the first adaptation value if the operating temperature is higher than a predefined first temperature threshold.

16. The device according to claim 7, wherein the first adaptation value is determined independently of the sensed operating temperature if the sensed operating temperature is lower than a predefined second temperature threshold, wherein the second temperature threshold is lower than the first temperature threshold.

17. The device according to claim 15, wherein the first adaptation value is determined as a function of the sensed operating temperature and the first and second temperature threshold if the sensed operating temperature is lower than or equal to the first temperature threshold and higher than or equal to the second temperature threshold.

18. The device according to claim 7, wherein the device is further configured
to store a value of the first weighting value if the operating temperature of the internal combustion engine is equal to the first temperature threshold,
to store a first value of the second weighting value if the operating temperature of the internal combustion engine is equal to the first temperature threshold,
to store a second value of the second weighting value at an end of the respective operating cycle of the internal combustion engine,
at the start of a subsequent operating cycle of the internal combustion engine, to predefine the first weighting value as a function of the stored value of the first weighting value and the stored first and second values of the second weighting value.
